(19) United States
(12) Patent Application Publication
(10) Pub. No.: US 2003/0226000 A1
(43) Pub. Date: Dec. 4, 2003

(54) Collapsible pipeline structure and method used in a microprocessor

(76) Inventor: Mike Rhoades, San Jose, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/063,977

(22) Filed: May 30, 2002

(51) Int. Cl. G06F 9/30

(52) U.S. Cl. 712/218; 712/219

(57) ABSTRACT

A collapsible pipeline structure, suitable for use in a microprocessor. The contains a first pipeline stage, under control by a clock to export a sequence of instruction stage results with respect to a clock cycle of the clock. A bypassing storage unit receives the sequence of instruction stage results and, when operating in collapsed mode, forwards that sequence onto the subsequent pipeline stage, bypassing the storage unit through a mutiplexer. A second pipeline stage receives the output from the bypassing storage unit, and exports its instruction stage results under control of the clock. Wherein if the collapsing function of the bypassing storage unit is disabled, then the instruction pipeline functions in the conventional manner.

### BACKGROUND OF INVENTION

1. Field of Invention

The present invention relates to technology of a microprocessor. More particularly, the invention relates to a collapsible pipeline used in a microprocessor.

2. Description of Related Art

In the design of a microprocessor, instruction throughput, i.e., the number of instructions executed per second, is of primary importance. The number of instructions executed per second may be increased by various means. The most straightforward technique for increasing instruction throughput is by increasing frequency at which the microprocessor operates. Increased operating frequency, however, is limited by fabrication techniques and also results in the generation of excess heat.

Thus, modern day microprocessor designs are focusing on increasing the instruction throughput by using design techniques which increase the average number of instructions executed per clock cycle period. One such technique for increasing instruction throughput is “pipelining.” Pipelining techniques segment each instruction flowing through the microprocessor into several portions, each of which can be handled by a separate stage in the pipeline. Pipelining increases the speed of a microprocessor by overlapping multiple instructions in execution. For example, if instruction could be executed in six stages, and each stage required one clock cycle to perform its function, six separate instructions could be simultaneously executed (each executing in a separate stage of the pipeline) such that one instruction was completed on each clock cycle. In this ideal scenario, the pipelined architecture would have an instruction throughput which was six times greater than the non-pipelined architecture, which could complete one instruction every six clock cycles.

A second technique for increasing the speed of a microprocessor is by designing it to be a “superscalar.” In a superscalar architecture, more than one instruction is per clock cycle (IPC). If no instructions were dependent upon other instructions in the flow, the increase in instruction throughput would be proportional to the degree of scalability. Thus, if an architecture were superscalar to degree 2 (meaning that two instructions issued upon each clock cycle), then the instruction throughput in the machine would double.

The stages of a microprocessor pipeline typically consist of a logic portion, which performs the function of that particular pipeline stage, whose output is captured by a flip-flop or latch storage unit when the clock advances to the next cycle. The output of the storage unit is then input to the subsequent pipeline stage, during the next clock cycle. In order for the microprocessor to function correctly at a given clock frequency, the logic portion of each pipeline stage must produce its result before the end of the clock cycle. The highest clock frequency for which this occurs is said to be the Maximum Operating Frequency (MOF) of the microprocessor. Ignoring the specific behavior of the system external to the microprocessor, the microprocessor can achieve its highest performance at the MOF, or in that case, it is able to execute the greatest number of instructions per second. If the clock frequency were increased above the MOF, then at least one of the pipeline stages would fail to meet the timing of its storage unit and the instruction flow though the pipeline would be broken at that clock frequency.

A microprocessor will naturally consume the most power and produce the most thermal output when operated at its MOF. For applications of a microprocessor where low power consumption (or thermal output) are required, the clock frequency can be slowed, reducing the power and the performance by a proportional amount. Similarly, the supply voltage can be lowered, yielding a power reduction proportional to the square of the drop in supply voltage, but this also reduces the MOF by the same proportion. A measure of the microprocessor's performance versus its consumed power (PvP) isn't improved by simply scaling the clock frequency and/or supply voltage, as done with the previous methods. As one might imagine, it is desirable to achieve the highest PvP possible, especially for low power applications. Conventional techniques such as clock gating and data re-circulation can be used to increase PvP, which work by effectively powering down logic that is idle for a particular clock cycle, while having little or no effect on performance. However, further increases in PvP for low power applications of a microprocessor are achievable.

FIG. 1A is a timing diagram, schematically illustrating the typical flow of instructions through a conventional, pipelined microprocessor running at its MOF. In FIG. 1A, our example pipeline consists of an instruction fetching stage (IF), instruction decoding stage (ID), register file read stage (RF), data processing stage (EX), data accessing stage (DC), and register file write stage (WB). The typical instruction throughput of this pipeline is 1 instruction per clock cycle, whereas the latency, or time it takes for an instruction to flow through the entire pipeline is 6 clock cycles.

FIG. 1B is a timing diagram, schematically illustrating the typical flow of instructions through our example pipeline, now running with a clock frequency that is appropriate for a low power application. More specifically, the clock frequency is scaled down to half the MOF, which reduces the power consumption of the microprocessor by a factor of 2. Unfortunately, with a conventional pipeline such as this one, the performance is reduced by the same factor of 2. For low power applications, the PvP of a microprocessor can be further improved over conventional methods alone, by using a collapsible pipeline, as the invention described hereafter.

### SUMMARY OF INVENTION

The invention provides a collapsible pipeline structure and method used in a microprocessor, so as to improve its PvP when the microprocessor is operated at clock frequencies that are fractionally lower than its MOF, as appropriate for low power and/or low thermal output applications of the microprocessor.

As embodied and broadly described herein, the invention provides a collapsible pipeline structure, suitable for use in a microprocessor. The structure consists of a group of two or more pipeline stages, sequentially ordered with respect to the instruction flow through the pipeline, whereby each of the conventional storage units internal to this group are replaced by a Bypassing Storage Unit. A conventional storage unit is still used following the last pipeline stage of the group. When the bypassing storage unit(s) are set in bypass (or collapsed) mode, the logic portions of the group's pipeline stages are connected together, serially, through a multiplexer built into the bypassing storage unit(s). In this mode, the group of N pipeline stages are said to be collapsed into a single stage. Assuming that each of the group's pipeline stages just meets timing with the microprocessor running at its MOF, then the group of N stages, when collapsed into 1 stage, will require a clock period that is approximately N times longer than that of the MOF (neglecting the timing penalty of the multiplexer(s)) in order to meet timing requirements. When not in bypass mode, the pipeline stages of the group function as they would, conventionally, with only a slight penalty to timing (MOF) due to the introduction of the multiplexer(s) along the instruction flow path.

The collapsible pipeline structure can be used in multiple instances within a microprocessors instruction pipeline, and it is not necessary for all groups of stages being collapsed to be of the same size nor is it a requirement that all pipeline stages be a participant in a collapsible group. For example, it might be impractical to include stages employing self timed or dynamic logic in a collapsible group. In the general case, when one or more collapsible groups or N-or-fewer stages are operating in collapse mode, the microprocessor's clock frequency must be scaled down by a factor of N (from its MOF) to properly function.

In FIG. 2, an example instruction pipeline has collapsible groups consisting of pairs of pipeline stages: instruction fetching and instruction decoding group (IF & ID), register file reading and data processing execution group (RF & EX), and data cache accessing and register file write-back group (DC & WB). When the instruction pipeline of the microprocessor is operating in conventional (or uncollapsed) mode and the clock frequency is a factor of 2 less than its MOF, a typical instruction takes 6 clock cycles to flow through the 6 stages of the pipeline (FIG. 1B). When operating in collapse mode at the same clock frequency, a typical instruction takes only 3 clock cycles to flow through the 3 collapsed stage groups (FIG. 2). For this example, the latency of the instruction pipeline in collapsed mode is improved by a factor of 2 compared to uncollapsed mode. Hence, when the microprocessor is running software with any degree of branch miss-predictability, the collapsed pipeline will outperform the uncollapsed one, if both are running at the same clock frequency. Moreover, if we assume the peak power consumption of collapsed and conventional (uncollapsed) modes running at the same clock frequency are similar, then the PvP of the collapsed mode will also be improved over the uncollapsed mode.

In the forgoing collapsible pipeline structure, the bypassing storage unit comprises a logic gate unit for receiving the clock and a collapse enable signal. A storage unit receives the sequence of instruction stage results from the first pipeline stage and exports the stored content output (delayed by one clock cycle) under control by a logic output from the logic gate unit. A multiplexer receives the sequence of instruction stage results from the first pipeline stage at a first terminal and the stored content output from the storage unit at a second terminal. Under control by the collapse enable signal, the multiplexer exports either the stored content or the sequence of instruction stage results from the first stage as the output of the bypassing storage unit.

In the forgoing collapsible pipeline structure, the logic gate unit of the bypassing storage unit comprises an AND logic gate.

In the forgoing collapsible pipeline structure, the multiplexer is a two-to-one multiplexer.

The invention also provides a method for configuring a microprocessor having a collapsible pipeline. The method comprises of selectively enabling or disabling the bypassing storage units within collapsible stage groups of the microprocessor's pipeline. Stage groups that are enabled for collapse behaive as a single pipeline stage with respect to one cycle of the clock, with the clock's frequency scaled down to less than approximately MOF/N when the corresponding number of stages in the collapsed group(s) is N or fewer. When the collapsible feature of a stage group is disabled, the pipeline stages within the group function as they would in a conventional pipeline, permitting clock frequencies of up to the MOF.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a timing diagram, schematically illustrating the typical flow of instructions through the pipeline unit, with the clock running at its MOF

FIG. 1B is a timing diagram, schematically illustrating the typical flow of instructions through the pipeline unit, with the clock running at half its MOF;

FIG. 2 is a timing diagram, schematically illustrating a flow of instructions through the collapsed pipeline, according to one preferred embodiment of this invention; and

FIG. 3 is a block diagram, schematically illustrating a bypassing storage unit used between two pipeline stages for collapsing the pipeline stages, according to one preferred embodiment of this invention.

### DETAILED DESCRIPTION

When a microprocessor is designed, the structure of the instruction pipeline is often determined by criteria such as target operating frequency and instruction throughput goals, which set limits on how much logic can be evaluated in a single clock cycle, and branch behavior and predictability of the target software, which can also influence the depth of the pipeline. In some cases, a microprocessor may be designed to operate at several clock frequencies, or over a range of operating frequencies. For this type of design, a single microprocessor design can be usable in various applications and operating environments, which may have different thermal power, and performance requirements. For such cases, the pipeline is designed into a architecture, according to the highest of the targeted operating frequencies, and then the clock frequency and/or the supply voltages can be scaled down to trade off performance for lower power consumption and thermal output as required by some applications of the microprocessor, such as PDAs, wireless phones, GPS units, MP3 players, etc. The invention can further reduce the power consumption and thermal output of the microprocessor while maintaining better performance for such applications, which can be used stand-alone or in conjunction with other methods.

The method of the invention includes the design directly on the microprocessor pipeline. For a sufficiently low operating clock frequencies, selected groups of two or more pipeline stages can be collapsed into single stages by powering down and bypassing the storage elements between them with a gated clock and a multiplexer, respectively. Which and how many stages are collapsed can be configured by such means as a set of input pins to the microprocessor or by issuing an explicit instruction for configuring the pipeline. For applications where maximum performance are desired, the pipeline would be configured in its conventional, or uncollapsed, mode and could operate at up to the microprocessor”s maximum operating frequency (MOF). If, for example, the target operating frequency for a particular application of the microprocessor is less than or equal to half of its MOF, the pipeline can be, for instance, configured with alternate pairs of pipeline stages being collapsed. In this manner, it would yield a pipeline with half the number of pipeline stages, having half the instruction latency compared to the uncollapsed configuration, which leads to improved effective throughput or performance (the peak throughputs for both configurations would be identical, however). Moreover, when running in either configuration, the pipeline would have very similar measures of peak power consumed and heat produced at a given clock frequency. As a result, PvP is increased by collapsing pipeline stages when the clock frequency is low enough to permit it. This means that in practice by collapsing the pipeline, either better performance can be achieved while maintaining the same envelopes for peak power consumption and thermal output as with the uncollapsed pipeline. Or, in the another case, similar performance can be achieved in collapsed mode reducing the envelopes for peak power consumption and thermal output (by decreasing the clock frequency even further for the collapsed pipeline case). It is conceivable, although likely impractical, that a microprocessor's instruction pipeline could be designed to collapse into a single stage when running at a sufficiently-low clock frequency.

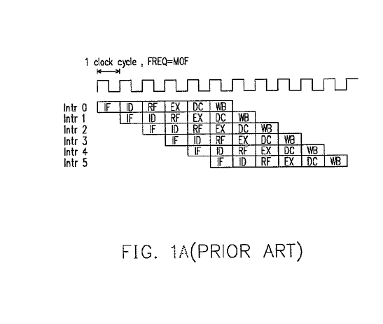

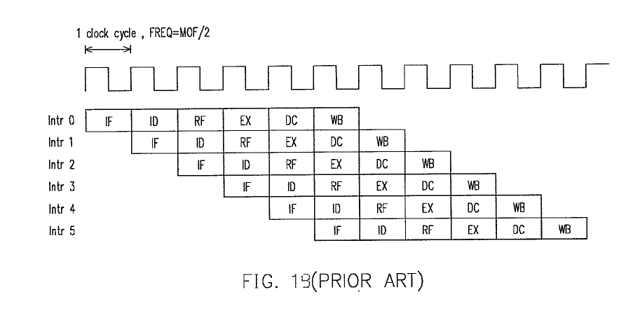

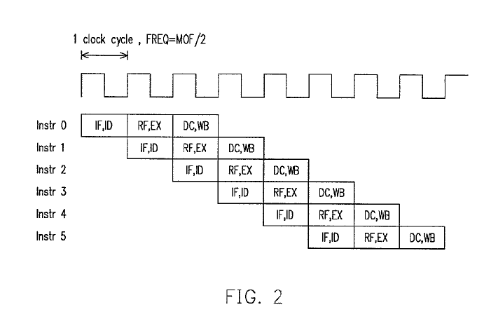

FIG. 2 shows a collapsed pipeline operating at half the MOF, while FIG. 1B showed the same pipeline operating in its uncollapsed configuration. It should be noted that the peak throughput of both uncollapsed and collapsed configurations are the (each completes execution of at most one instruction per clock cycle), yet the latency for the collapsed pipeline is half that of the uncollapsed pipeline. Again, with its fewer stages with respect to the clock, the collapsed pipeline would have improved performance over the uncollapsed pipeline, assuming the software being executed isn't perfectly predictable in terms of its branch behavior.

In more detail, FIG. 2 is a timing diagram, schematically illustrating a flow of instruction through the collapsed pipeline, according to one preferred embodiment of this invention. In FIG. 2, the pipeline includes the instruction stages of IF, ID, RF, EX, DC, and WB. At the discretion of the designer of the pipeline, the six instruction can be partitioned into collapsible groups, where each group includes one or more instruction stages that ordered sequentially according to the instruction flow through the pipeline. In a collapsed configuration, the two of more stages of each collapsible group function as a single pipeline stage with respect to clock, with each storage units internal to a collapsible group of pipeline stages being powered down (via clock gating) and bypassed through a multiplexer. In the example of FIG. 2, the instruction stages are partitioned into pair-wise collapsible groups, such that when the operating clock frequency is scaled to approximately less than or equal to half of its MOF, the collapsible groups can be configured to operate in collapse mode and not result in a timing failure. In this manner, the instruction stages 1F and 1D are grouped into one single stage, the instruction stages RF and EX are grouped into another single stage, and the instruction stages DC and WB are grouped into the third single stage. As a result, in the collapsed mode, the pipeline now includes only three stages with respect to three clock cycles and has improved PvP on most software (having any degree of branch miss-predictability).

As mentioned before, which and how many of the instruction stages to be collapsed can be configured externally via a set of input pins to the processor or via an explicit instruction issued to the microprocessor at runtime. The example by pair manner as shown in FIG. 2 is just a possible configuration. If more instruction stages are to be collapsed, the same principle can be applied. Additionally, the number N of instruction stages for each single stage group is not necessary to be 2 and need not be the same for each one of the groups. It is only necessary that the clock frequency be accordingly reduced from the microprocessor's MOF in order to meet timing. In the general case, the clock frequency would need to be reduced by a factor of N from the MOF if groups of N or fewer pipeline stages are collapsed.

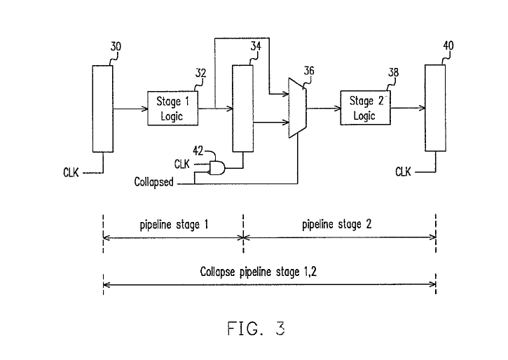

In order to perform the collapsing method for the pipeline, a hardware design is also provided. FIG. 3 is a block diagram, schematically illustrating a bypassing storage unit used between two pipeline stages for collapsing the pipeline stages, according to one preferred embodiment of this invention. In FIG. 3, the novel collapsed pipeline structure particularly includes a bypassing storage unit, which includes, for example, flip-flop or a latch followed by a 2-to-I multiplexer, such that the storage element can be switched in or out of the circuit path. When the storage element is switched out of the circuit path, the clock signal for driving the bypassing storage unit is stopped, thereby further reducing the power. The bypassing storage unit can be inserted in between any two or more consecutive pipeline stages of a collapsible stage group, which is a group of pipeline stages that are designed to be functioned as a single pipeline stage when the collapse enable signal is set and the bypassing storage units are operating in collapse mode. In addition, the bypassing storage unit of the invention further includes, for example, control logic that would generate the appropriate control signals to collapse the pipeline stages (or not). It is based on the values of either external pins of the microprocessor or the explicit instruction issued to configure the pipeline, depending on which method is employed. A further portion of logic may be required in special cases, for example, to guarantee that the pipeline operates correctly in all collapsed (and uncollapsed) configurations, and/or would otherwise disallow configurations for which correct operation of the microprocessor cannot be guaranteed.

In more details as shown in FIG. 3, the collapsible pipeline structure includes a bypassing storage unit, which here is implemented between two pipeline stages, but can be used is a similar manner in a group of N pipeline stages of a collapsible group. The pipeline stage 1 includes a storage element 30 and a stage-1 logic circuit 32, coupled in series. The bypassing storage unit includes a storage element 34, a multiplexer unit 36, and a logic gate circuit 42. The pipeline stage 2 includes a stage-logic circuit 38 and a storage element 40.

The bypassing storage unit is used to collapse the pipeline stage 1 and the pipeline stage 2 into a single collapsed stage. In the bypassing storage unit, the storage element 34 receives the instruction stage outputting from the pipeline stage 1. The storage element 34 can include, for example, a flip-flop circuit or a latch circuit. The storage element 34 is controlled by the output of the logic gate circuit 42, so as to export the stored at the corresponding clock cycle. The multiplexer 36 receives the output from the storage element 34 at one terminal and the output from the pipeline stage 1 at another terminal. The logic gate circuit 42 can include, for example, an AND logic gate. The logic gate circuit 42 receives the clock CLK, and a collapse enable signal. The collapse enable signal is also sent to the multiplexer 36. An inverter can also be included in the logic gate circuit 42 to invert the collapse enable signal. However, this is a design choice.

When the clock CLK and the collapse enable signal are received by the logic gate circuit 42, a logic output is exported to the storage element 34 for passing the content to the multiplexer 36. However, the output of the pipeline stage 1 is also bypassed to the multiplexer 36. The multiplexer 36 is also controlled by the collapsed enable signal, so as to select the right one of the collapsed instruction stage results, which are the stored or previous one and the bypassed, or current one in this example. In this manner, the storage element 34 can be switched in or out of the circuit path. The stage logic circuit 32, 38 are used to guarantee that the pipeline operates correctly in all collapsed and uncollapsed configurations.

It should be noted that the hardware circuit design in accordance with the feature of collapsing the instruction stages can have various design choices. For example, the multiplexer is not necessary to be only choice with the type of 2-to-1 multiplexer, nor need it be a multiplexer used exclusively for its function in the bypass storage unit. To improve timing, for example, it could be merged with another multiplexer (MUX) that would follow it in the circuit path (adding extra legs to the bypassing storage unit's MUX in order to eliminate the second MUX.) In the same manner, it is not necessary that the storage element be a standard flip-flop or latch circuit. The same principles would apply if another storage unit type were employed in its place.

In summary, the invention first introduces a collapsing manner for the instruction stages when the operating clock frequency is allowed. The advantage by using this method and apparatus is that it can achieve better PvP than that by the conventional methods. When the operating frequency is decreased and pipeline stages are collapsed, even though the peak throughput of the machine is reduced proportionally (as also occurs in the uncollapsed pipeline running at the same instruction with the reduced frequency), the performance or effective throughput of the collapsed pipeline is improved due to its shallower pipeline. In collapsed mode, the pipeline can significantly outperform the pipeline in uncollapsed mode on software code with any degree of branch miss-predictability when both are running at the same frequency. At the same time, by powering down the bypassed storage elements of collapsed stages, this approach offers lower worst case power consumption than that of the uncollapsed pipeline when running at the same frequency, which would occur when the pipelines are operating at or near their peak throughputs. Ultimately, this means that the operating frequency (and hence the power consumption and thermal output) can be even further reduced from the design without using collapsing method while the performance requirements remain the same.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A collapsible pipeline structure, suitable for use in a microprocessor, the structure comprising:
a first pipeline stage, under control of a clock to export a sequence of instruction stage results, one result per clock cycle;
a bypassing storage unit, which receives the sequence of instruction stage results from the first pipeline stage and either captures the sequence in a storage unit with respect to the clock and exports the stored output sequence delayed by one clock cycle, or when operating in collapsed mode, exports the sequence of results from the first stage, directly, bypassing the storage unit; and
a second pipeline stage, which receives the output sequence from the bypassing storage unit, and exports a sequence of results for the second instruction stage, under control of the clock,
wherein if the collapsing function of the bypassing storage unit is enabled through the collapse enable signal, then the first and second pipeline stages are collapsed into a single pipeline stage with respect to the clock, exporting a sequence of collapsed instruction stage results that are the aggregate results of the instruction sequence passing through the first and second pipeline stages, in order;
wherein if the collapsing function of the bypassing storage unit is disabled through the collapse enable signal, then the instruction stages function in an uncollapsed mode.

2. The collapsible pipeline structure of claim 1, wherein the bypassing storage unit comprises:
a logic gate unit, receiving the clock and a collapse enable signal;
a storage unit, receiving the sequence of instruction stages from the first pipeline stage and exporting a stored content output under controlled by a logic output from the logic gate unit; and
a multiplexer, receiving the sequence of instruction stage results from the first pipeline stage at a first terminal and the stored result sequence from the storage unit at a second terminal, under control by the collapse enable signal to select one of them as an output of the bypassing storage unit.

3. The collapsible pipeline structure of claim 2, wherein the logic gate unit of the bypassing storage unit comprises an AND logic gate.

4. The collapsible pipeline structure of claim 2, wherein the logic gate unit and the multiplexer of the bypassing storage unit are designed together, whereby the logic gate unit receives an inverse logic state of the collapse enable signal while the multiplexer receives an original logic state of the collapse enable signal.

5. The collapsible pipeline structure of claim 4, wherein the logic gate unit comprises an AND logic gate with an inverter at the terminal for receiving the collapse enable signal.

6. The collapsible pipeline structure of claim 2, wherein the storage unit of the bypassing storage unit comprises a flip-flop circuit.

7. The collapsible pipeline structure of claim 2, wherein the storage unit of the bypassing storage unit comprises latch circuit.

8. The collapsible pipeline structure of claim 2, wherein the multiplexer of the bypassing storage unit is a two-to-one multiplexer.

9. The collapsible pipeline structure of claim 1, wherein the number of the instruction stages being collapsed is two.

10. The collapsible pipeline structure of claim 1, wherein the first pipeline stage comprises a first storage unit controlled by the clock and a stage-1 logic circuit coupled in series.

11. The collapsible pipeline structure of claim 1, wherein the second pipeline stage comprises a stage-2 logic circuit to receive the output from the bypassing storage unit, and a second first storage unit coupled in series after the stage-2 logic circuit and controlled by the clock.

12. A method for configuring the collapsible pipeline structure in a microprocessor under control of a clock for executing instructions, the method comprising:
grouping the pipeline stage by selecting N number of consecutive pipeline stages with respect to the instruction flow through the pipeline as a group, for which bypassing storage units are employed between each of the N pipeline stages of the group, and for each;
collapsing the group as a single stage under control of a clock and with respect to a clock cycle, when the instructions are operated at a low speed least less than or equal to approximately a fraction 1/N times the maximum operation speed of the processor; and
selecting one of the pipeline stages in the corresponding group as an output at the desired clock cycle.

13. The method of claim 12, wherein the N number is equal to 2.

14. A method for configuring a pipeline structure associating an instruction having a plurality of instruction stages under a collapsing operation mode, the method comprising:
partitioning the pipeline stages into a plurality of collapsible stage groups, each one of the collapsible groups including a plurality of the pipeline stages and is treated as a single stage with respect to a clock cycle.

15. The method of claim 14, wherein each one of the collapsible stage groups comprises of two pipeline stages.
